(19) United States
(12) Patent Application Publication
(10) Pub. No.: US 2010/0122621 A1
(43) Pub. Date: May 20, 2010

(54) DIATONIC MAPPING SYSTEM OF THE GUITAR FRETBOARD

(76) Inventor: Mark A. Newstetter, San Francisco, CA (US)

Correspondence Address: RAY K. SHAHANI, ESQ., ATTORNEY AT LAW, TWIN OAKS OFFICE PLAZA, 477 NORTH NINTH AVENUE, SUITE 112, SAN MATEO, CA, 94402-1858, US

(21) Appl. No.: 12/273,469

(22) Filed: Nov. 18, 2008

(51) Int. Cl. G10D 3/06

(52) U.S. Cl. 84/314 R

(57) ABSTRACT

A mapping system consisting of a set of diagrams delineating and identifying the diatonic arrangement of tones on the guitar fretboard based upon the principal of radial symmetry providing musicians with a way of finding notes on the guitar fretboard and understanding their diatonic relationships. These maps comprise several views of the diatonic system on the fretboard which take into account the varying position of the entire system of notes in each diatonic key. A framework of Zones and String Groups is laid out in a manner similar to a geographical map of the Earth which depicts the tones of each key as geometric configurations which are defined in terms of diatonic music theory.

### FIELD OF THE INVENTION

The invention relates to a method of music instruction and practice, and more particularly to a method of organization of diatonic tones on a guitar fretboard in the form of maps and related method of mapping of the guitar fretboard for the purpose of instruction and practice.

### BACKGROUND OF THE INVENTION

The guitar is a polyphonic musical instrument the design of which has evolved over centuries in conjunction with the diatonic system of music, which is the primary system for western music. Inasmuch as the guitar is used to play chords and melodies it plays a similar role to the piano both as a solo instrument, as an accompaniment to singing or as part of a musical ensemble.

Unlike the piano, the guitar does not present the musician with a clear means of identifying the notes of a given musical key. On the piano the notes of the key of C are plainly visible as the white piano keys.

The Key of C is the fundamental template for all 12 keys of the standard diatonic system in music. Because of this, a piano keyboard is designed to make C the easiest key to play. On the piano, all the notes of the key of C are produced by playing the white piano keys. The black keys on the piano are notes which are not part of the key of C, but belong to other keys.

The inherent logic and symmetry of the diatonic system is hidden in the note arrangement of the fretboard. So far there has been no standard for mapping the diatonic system as it exists on the fretboard. There has been no standard for assigning names to the various geometric patterns which comprise the diatonic keys, scales and modes on the guitar fretboard.

Finding the notes of the key of C, or any other key, on the guitar is not as simple as it is on the piano since there is no visible pattern of notes on the guitar fretboard. When the array of notes on the guitar is depicted as a simple diagram, it is not a clear linear sequence as it is on the piano keyboard since the notes are arrayed across the six strings which are not all tuned to the same musical interval.

Students of the guitar struggle to learn the positions of tones on the fretboard. Finding notes on the guitar is such a difficult process that beginning players are most likely to learn the instrument without attempting to learn the names of the notes or where they are positioned, instead of learning chords and scales as geometric patterns by rote memory. Typically, chord and scale patterns on the guitar are learned without any awareness of their relationships to the diatonic system as a whole as it is arrayed on the fretboard.

Conventional approaches to learning the note positions on the guitar are based on linear progressions from the open string position up the fretboard one fret position at a time. Patterns are usually named for their relative fret positions; Pattern 1, Pattern 2, or some such essentially arbitrary terminology with no clear musical significance. There is currently no standard map of the diatonic system as a whole for the guitar fretboard. One is needed and the present invention provides such a practical and comprehensive map.

FIG. 1 (prior art) is a representative schematic view of a traditional regular fretboard 90 of a guitar. As shown in FIG. 1, the notes of the key of C, the natural tones, without a method of organization appear to be arrayed randomly on the guitar fretboard 90. And as discussed, users need to learn the exact positions of these tones by raw memorization.

As shown in FIG. 1, horizontal lines represent strings 3 of the guitar with the bottom line being the lowest pitched string and the top line being the highest pitched string. The leftmost vertical line 1 represents the nut across which the strings pass at the head of the instrument and the point at which the lowest note on each string is found. The rest of the vertical lines represent the frets 4. In one embodiment, frets 4 are metal strips, usually nickel alloy or stainless steel, embedded along the fretboard 90 and located at exact points that divide the scale length in accordance with a specific mathematical formula.

### ADVANTAGES AND SUMMARY OF THE INVENTION

It is an object and advantage of the present invention to provide a comprehensive means for guitarists to study and understand the diatonic system of music as it pertains to the geometric arrangement of tones on the guitar fretboard.

This invention is a system of mapping the diatonic system of music on the standard guitar fretboard and the maps themselves. The principle of the invention is symmetry and the identification and delineation of symmetrical patterns of tone positions within the array of diatonic tones on the guitar fretboard.

Specific geometric relationships of the positions of diatonic tones are assigned names and presented as diagrammatical maps which can be used to navigate the fretboard in the process of playing mu sic.

The essence of the system presented here is its treatment of the diatonic system on the fretboard as a symmetrical array rather than a linear sequence. This array is applied to all the diatonic keys and is consistent with standard music theory. Within each key, patterns can be found in Zones consisting of Groups of strings and frets. These Zones are identified by terminology which relates the geometric patterns of notes on the fretboard with basic music theory providing the guitarist with a useful way of understanding and remembering the patterns.

The maps are created by first dividing the fretboard longitudinally into two basic Zones and latitudinally into two basic Groups of strings which together function somewhat like the hemispheres on a geographical map of the Earth.

The two Zones are analogous to the eastern and western hemispheres and the String Groups can be said to correspond to the northern and southern hemispheres of the map. Specific fret positions are referred to as ‘Axes’, of which there are three. These Axes comprise the boundaries of the Zones, and the 4th string functions as an equator bisecting the Zones and separating the Upper and Lower String Groups, much as the Earth's equator bisects the eastern and western hemispheres to form the northern and southern hemispheres.

This basic method of delineating the grid of the fretboard provides a context for understanding the symmetry of the diatonic array. Once the Zones and String Groups are delineated, the diatonic half-steps are then shown as note Clusters positioned symmetrically within each String Group.

The symmetrical delineation of the fret-board into Zones and String Groups is an invention which presents a new way of viewing of all the diatonic keys on the guitar. Also the identification of geometrically symmetrical diatonic patterns simplifies the process of learning and playing musical scales and modes and facilitates a comprehensive understanding of standard diatonic music theory as it relates specifically to the guitar.

The tonal array is understood, by means of this invention, as a clearly symmetrical array which can be depicted in any key using either alphabetical note names or Roman numerals to indicate scale degrees.

The maps comprise several views. One view shows the diatonic array as an eleven fret span with a single central Axis and an Axis at the lowest and highest of the eleven frets. Another view reverses the orientation, whereby the central Axis of the aforementioned view is found at the extreme ends of a fifteen fret span, and the two other Axes are positioned in the middle. These two basic views present different symmetrical perspectives of the diatonic array. Depending on the key in which a given piece of music is set, one view or the other may be preferable. The two views together cover all the diatonic possibilities of the fretboard.

Numerous other advantages and features of the present invention will become readily apparent from the following detailed description of the invention and the embodiments thereof, from the claims and from the accompanying drawings.

### BRIEF DESCRIPTION OF THE DRAWINGS

FIG. 1 (prior art) is a schematic view of the traditional guitar fretboard 90.

FIG. 2 is a schematic view of the fretboard 100 alignment of natural tones in certain fret positions.

FIG. 3 is a schematic view of the fretboard 100 showing delineation of Upper and Lower String Groups.

FIG. 4 is a schematic view of the fretboard 100 showing the diatonic half-steps in the four upper strings.

FIG. 5 is a schematic view of the fretboard 100 showing the diatonic half-steps in the three lower strings.

FIG. 6 is a schematic view of the fretboard 100 showing diatonically symmetrical strings of notes resembling the arms of a spiral galaxy.

FIG. 7 is a schematic view of all the diatonic half-steps on the fretboard 100 in the key of C.

FIG. 8 is a schematic view of the fretboard 100 showing a range of eleven frets with Roman numerals representing diatonic scale degrees.

FIG. 9 is a schematic view of the fretboard 100 showing a range of fifteen frets with Roman numerals I to VII representing diatonic scale degrees C to B, respectively.

FIG. 10 is a schematic view of the fretboard 100 showing four upper and three lower strings as separate Groups over an eleven fret span.

FIG. 11 is a schematic view of the fretboard 100 showing four upper and three lower strings as separate Groups over a fifteen fret span.

FIG. 12 is a flow chart showing the sequence of steps of the method of diatonic mapping system of the guitar fretboard 100 of the present invention.

### DETAILED DESCRIPTION OF THE PREFERRED EMBODIMENT

The description that follows is presented to enable one skilled in the art to make and use the present invention, and is provided in the context of a particular application and its requirements. Various modifications to the disclosed embodiments will be apparent to those skilled in the art, and the general principals discussed below may be applied to other embodiments and applications without departing from the scope and spirit of the invention. Therefore, the invention is not intended to be limited to the embodiments disclosed, but the invention is to be given the largest possible scope which is consistent with the principals and features described herein.

It will be understood that in the event parts of different embodiments have similar functions or uses, they may have been given similar or identical reference numerals and descriptions. It will be understood that such duplication of reference numerals is intended solely for efficiency and ease of understanding the present invention, and are not to be construed as limiting in any way, or as implying that the various embodiments themselves are identical.

FIG. 2 is a schematic view of the fretboard 100 alignment of natural tones in certain fret positions.

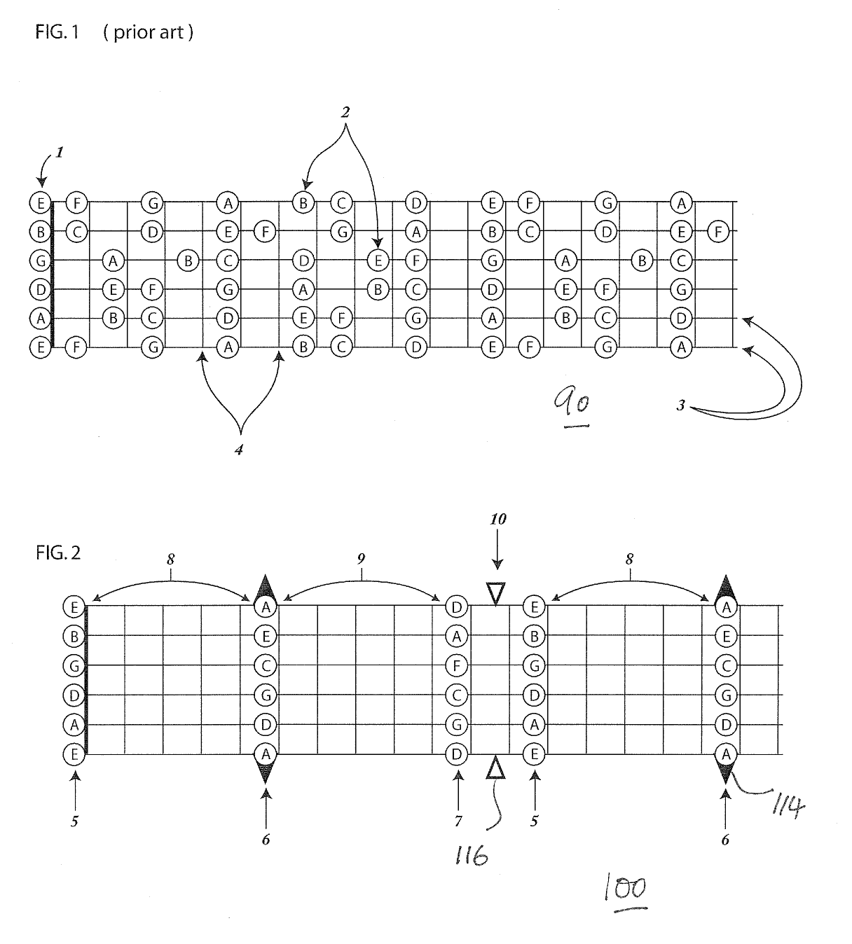

This view and all subsequent views, as well as FIG. 1 (prior art) are oriented from the perspective of one playing the guitar and looking down at the fretboard whereby the head of the guitar is at one's left. The pitches of tones on each string ascend as one progresses from left to right. All of the drawings are oriented thus.

The notes of the open strings 1 are the starting point for the fretboard 100. The rest of the notes 2 are arrayed across the strings 3 at a variety of fret positions 4.

As shown in FIG. 2, each string 3 is named for its open position note; E, A, D, G, B, E. Numbers are also traditionally used to name the strings. From the highest pitched string to the lowest the numbering system is: E=1st string, B=2nd string, G=3rd string, D=4th string, A=5th string, E=6th string.

There are several fret positions, viz. 5, 6 and 7, on the fretboard 100 where each position has a unique set of five of seven natural tones C, D, E, F, G, A and B, on each of the six strings. Each of these positions is referred to as an Axis. The Axes are named for the diatonic mode which is based upon the note found on the 1st and 6th string, ie; E is the note upon which the Phrygian mode is based in the key of C, thus the Axis based on E is the Phrygian Axis 5. Likewise, the Axis based on A is the Aeolian Axis 6. The axis based on D is the Dorian Axis 7.

Between the Axes 5, 6 and 7 are two Zones 8 and 9, comprising four fret spaces each. These Zones are named for the same diatonic modes as the Axis which borders each Zone's lowest position (at the left of that Zone) ie: the Phrygian Zone 8 is based on the Phrygian Axis 5, and the Aeolian Zone 9 is based on the Aeolian Axis 6. The Aeolian Axis is also marked in the maps by means of an outward pointing black triangular cap 114 on the top and bottom. This special emphasis on the Aeolian Axis 6 is due to it being the central Axis around which the diatonic symmetry is arrayed.

After the Dorian Axis 7 there is a fret position 10 at which there are no natural tones on any of the six strings. This fret position is referred to as the Void Position 10. The Void Position 10 is also marked in the maps by means of an inward pointing outlined triangular cap 116 on the top and bottom. The Void position 10 represents a secondary fulcrum for the diatonic symmetry.

After the Void Position 10, the other Axes and Zones are repeated in a higher octave.

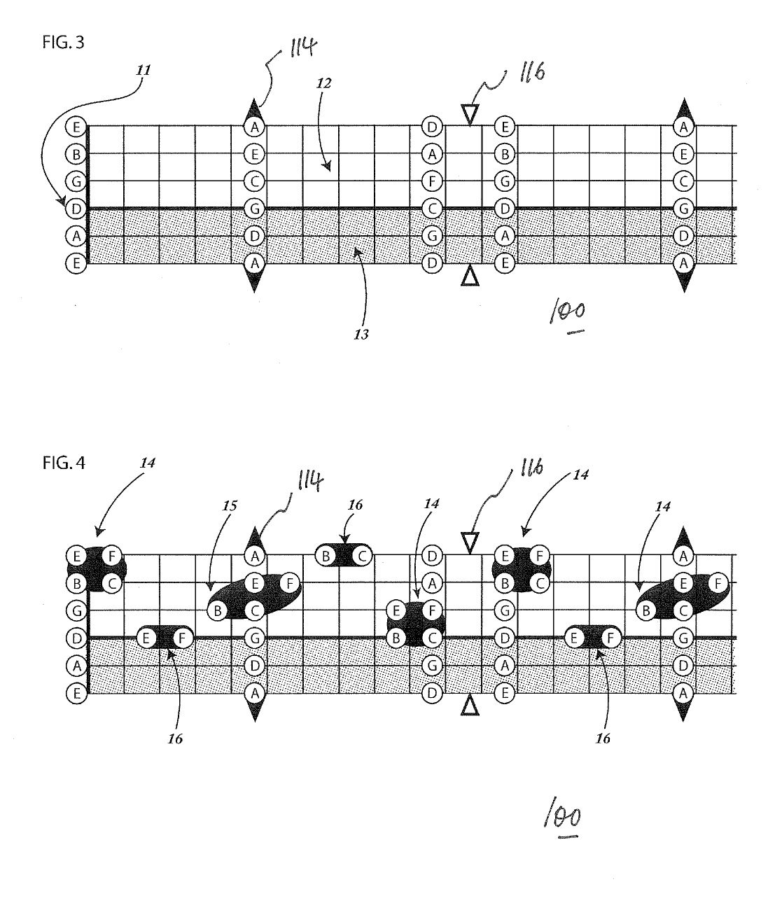

FIG. 3 is a schematic view of the fretboard 100 showing delineation of Upper and Lower String Groups.

While the aforementioned Axes form boundaries across the strings which define the Zones, the strings themselves are grouped to form two subdivisions.

The 4th string 11, shown as a heavier horizontal line, is used as a shared boundary between the Upper String Group 12—comprising the 1st, 2nd, 3rd & 4th strings (white area of the maps)—and the Lower String Group 13—comprising the 4th, 5th & 6th strings (the gray area of the maps).

FIG. 4 is a schematic view of the fretboard 100 showing Clusters of the diatonic half-steps in the four upper strings.

The next elements of these maps are the diatonic half-steps 14, 15 and 16. In every diatonic key there is a half-step between the 3rd & 4th and between the 7th and the tonic. In the key of C, these scale degrees are represented by E & F and B & C respectively. On a piano keyboard you can easily find these tones because they are the ones with no black keys between them.

These tones are landmarks of the diatonic system and the piano keyboard and are no less important to the guitarist. They provide a set of focal points which are distributed symmetrically across each String Group.

The half-steps form Clusters on adjacent strings the basic Clusters 14, emphasized by black ovals. These Clusters span two frets and two strings each. One of these Clusters is attached to the Phrygian Axis 5, the other is attached to the Dorian Axis 7. At the Aeolian Axis 6 is a Cluster which appears tilted or skewed and spans three frets. This is the Central Cluster or Core Cluster 15.

On the 1st and 4th strings are Partial Clusters 16. The lower Partial Cluster, on the 4th string, straddles the boundary between the Upper String Groups 12 and Lower String Groups 13 and is really part of a full Cluster of four notes when both String Groups 12 and 13 are seen. When the Upper String Group 12 is viewed by itself, the symmetry of the positions of these Clusters is quite clear and provides a useful means of navigating the fretboard 100. With the Axes and Clusters shown there are only a few additional tones to complete the map.

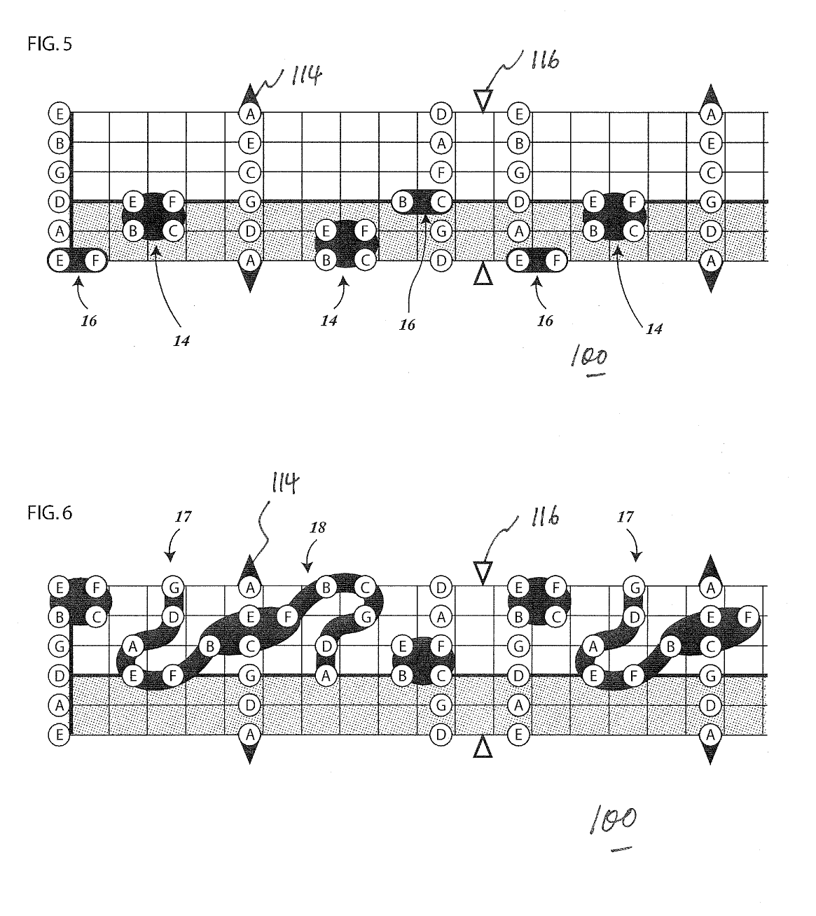

FIG. 5 is a schematic view of the fretboard 100 showing Upper Clusters of the diatonic half-steps in the three lower strings.

As shown in FIG. 4, when the Lower String Group 13 is viewed by itself, the symmetrical pattern is clear. The arrangement of Half-step Clusters 14 and 16 around the Aeolian Axis 6 and the Void position 10 almost completes the map.

FIG. 6 is a schematic view of the fretboard 100 showing diatonically symmetrical strings of notes of the Upper String Group graphically resembling the arms of a spiral galaxy.

When all the remaining tones are added to the already mapped Axes 6 and Half-step Clusters, and when they are connected to one another, a pattern resembling a spiral galaxy emerges 17 and 18. One of these Spiral Arms 17 is within the Upper String Group of the Phrygian Zone 8, the other Spiral Arm 18 is inside the Aeolian Zone 9. They are referred to as the Left Arm 17 and Right Arm 18.

There are other ways to connect the note positions in symmetrical patterns, however the Spiral Galaxy metaphor is an iconic/graphic way of showing the principle of diatonic symmetry on the fretboard 100. As with other features of the maps, they may or may not be shown depending on the particular purpose at hand, just as one would make use of various elements in a standard geographical map to show either roads, topographical features or political boundaries.

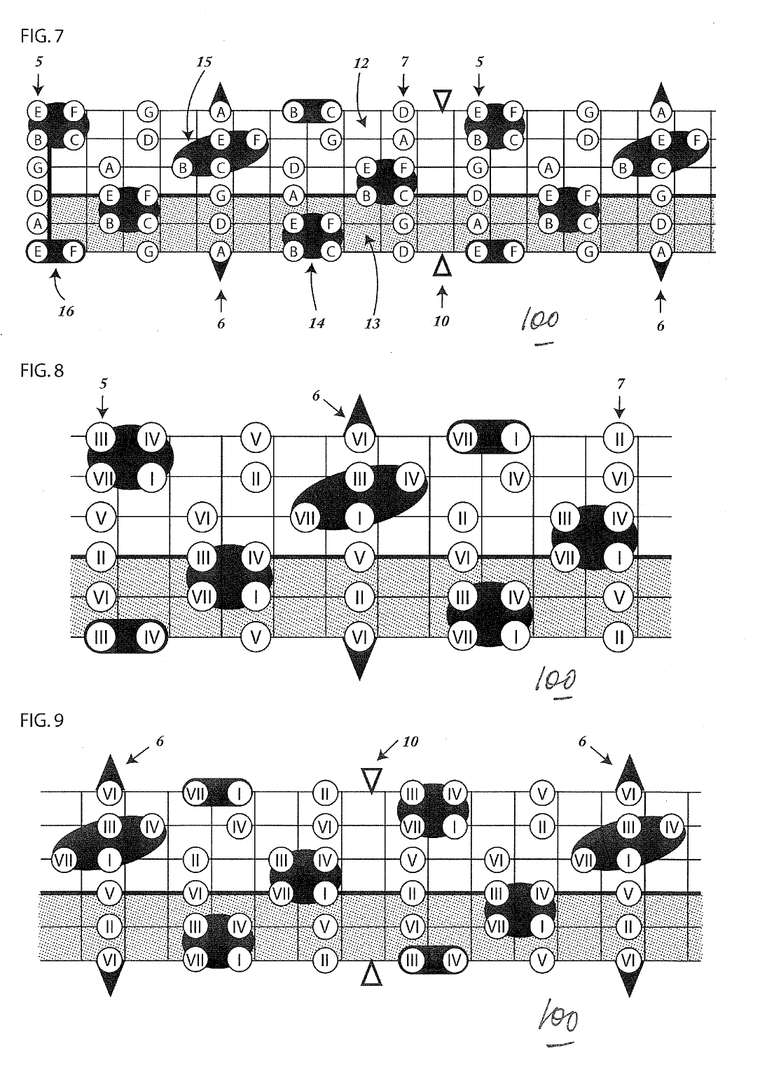

FIG. 7 is a schematic view of Clusters of all the diatonic half-steps on the fretboard 100 in the key of C.

This is the fretboard map showing all the notes of the key of C with the Half-step Clusters 14, 15 and 16 of the Upper String Group 12 and Lower String Group 13, and the triangular caps 114 and 116 emphasizing the Aeolian Axis 6 and the Void position 10 respectively.

FIG. 8 is a schematic center view of the fretboard 100 showing a range of eleven frets with Roman numerals representing diatonic scale degrees. As best shown in FIGS. 8 through 11, note names C to B are presented using Roman numerals I to VII as follows: I=C, II=D, III=E, IV=F, V=G, VI=A and VII=B.

As shown in FIG. 8, this view comprises the entire system spanning from the Phrygian Axis 5 to the Dorian Axis 7 with the Aeolian Axis 6 at dead center. Scale degrees are used instead of note names so that the map can be applied to any or every diatonic key.

FIG. 9 is a schematic view of the fretboard 100 showing a range of fifteen frets with Roman numerals I to VII representing diatonic scale degrees C to B and Void Position 10.

This view comprises the entire system with the Aeolian Axis 6 at each end. In each key the diatonic system as a whole is based on different fret positions, so the Aeolian Axis 6 may be found at the 2nd fret, as in the key of A, or the 3rd fret, as in the key of B flat. It is then more useful to use a map which places the Void 10 at the middle.

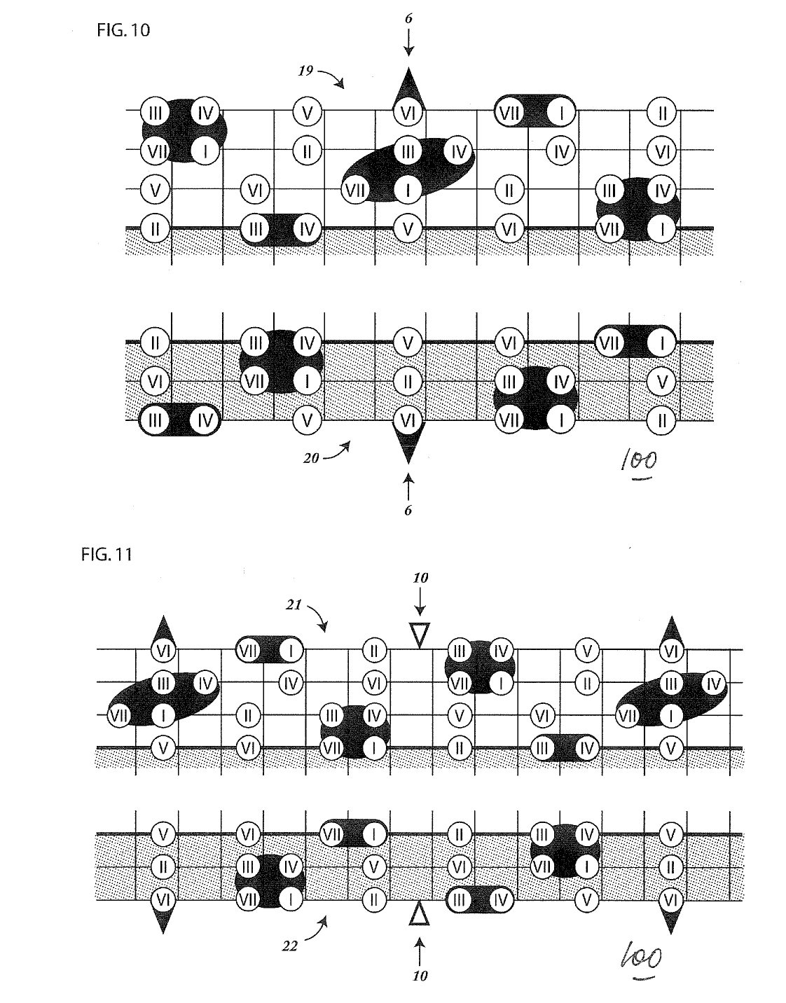

FIG. 10 is a schematic center view of the fretboard 100 showing four upper and three lower strings as separate Groups over an eleven fret span.

When focusing on musical ideas which are played within either the Upper String Group 19 or Lower String Group 20, it is useful to isolate one or the other. When doing so, each String Group may be shown separately so that the symmetry of each Group is then more clear.

FIG. 11 is a schematic view of the fretboard 100 showing four upper and three lower strings as separate String Groups over a fifteen fret span with the Void Position 10 at the center.

As best shown in FIG. 10, the Upper String Group 21 and Lower String Group 22 are separated for greater clarity in this view which places the Void 10 at the middle.

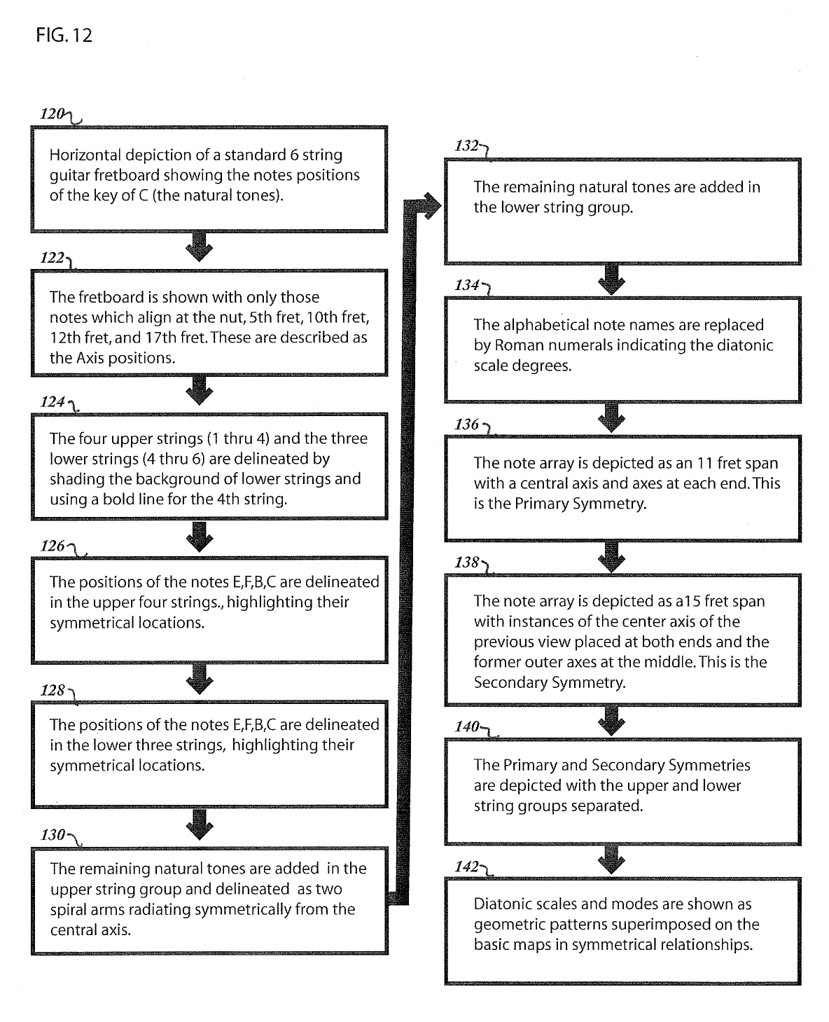

FIG. 12 is a flow chart showing the sequence of steps of the method of diatonic mapping system of the guitar fretboard 100 of the present invention. The following is also a method and system for teaching guitar, a method and system for representing graphically a diatonic map of the guitar fretboard, and a method and system for teaching music. The method consists of the following steps:

In step 120, horizontal depiction of a standard 6-string guitar fretboard shows the note positions of the key of C (the natural tones).

In step 122, the fretboard is shown with only those notes which align at the nut, 5th fret, 10th fret, 12th fret, and 17th fret. These are described as the Axis positions.

In step 124, the four upper strings (1 thru 4) and the three lower strings (4 thru 6) are delineated.

In step 126, the positions of the notes E,F,B,C are delineated in the upper four strings, highlighting their symmetrical locations.

In step 128, the positions of the notes E,F,B,C are delineated in the lower three strings, highlighting their symmetrical locations.

In step 130, the remaining natural tones are added in the Upper String Group and delineated as two spiral arms radiating symmetrically from the central Axis.

In step 132, the remaining natural tones are added in the Lower String Group.

In step 134, the alphabetical note names are replaced by Roman numerals indicating the diatonic scale degrees.

In step 136, the note array is depicted as an eleven fret span with a central Axis and Axes at each end. This is the Primary Symmetry.

In step 138, the note array is depicted as a fifteen fret span with instances of the center Axis of the previous view placed at both ends and the former Outer Axes at the middle surrounding the Void. This is the Secondary Symmetry.

In step 140, the Primary and Secondary Symmetries are depicted with the Upper and Lower String Groups separated.

In step 142, diatonic scales and modes are shown as geometric patterns superimposed on the basic maps in symmetrical relationships.

Further embodiments of the present invention include the use of electronic and digital technology. Optionally, electronic sensors located can be embedded in or inlaid upon the guitar fretboard. Such sensors can be powered internally such as through the use of batteries or solar cells, or from an external power source. Circuitry can be microelectronics and/or semiconductor-based, including high-speed processors for rapidly providing multi-media graphics, lights and sound, etc.

The present invention can also be recreated or reproduced on CD-ROM, visualizations including PowerPoint or other computer graphics-based systems can be employed. The invention can also be incorporated into memory sticks or other disc applications, as may be desired. The physical fretboard can be rendered virtual through the use of game consoles and multi-media workstations, and the diatonic notes of the virtual fretboard can be incorporated into games, teaching systems, training and performing.

Unless defined otherwise, all technical and scientific terms used herein have the same meaning as commonly understood by one of ordinary skill in the art to which the present invention belongs. Although any methods and materials similar or equivalent to those described can be used in the practice or testing of the present invention, the preferred methods and materials are now described. All publications and patent documents referenced in the present invention are incorporated herein by reference.

While the principles of the invention have been made clear in illustrative embodiments, there will be immediately obvious to those skilled in the art many modifications of structure, arrangement, proportions, the elements, materials, and components used in the practice of the invention, and otherwise, which are particularly adapted to specific environments and operative requirements without departing from those principles. The appended claims are intended to cover and embrace any and all such modifications, with the limits only of the true purview, spirit and scope of the invention.

1. A mapping system of the guitar fretboard comprising a sequential depiction of the diatonic musical keys as symmetrical arrays of notes superimposed over the fretboard of a guitar, further including the use of electronic and digital technology, such as electronic sensors embedded in or inlaid upon the guitar fretboard, the electronics powered internally such as through the use of batteries or solar cells, or from an external power source, also including microelectronics and/or semiconductor-based circuitry, including high-speed processors for rapidly providing multi-media graphics, lights and sound, etc.

2. (canceled)

3. A mapping system of the guitar fretboard comprising a sequential depiction of the diatonic musical keys as symmetrical arrays of notes superimposed over the fretboard of a guitar recreated or reproduced on CD-ROM, visualizations including PowerPoint or other computer graphics-based systems, and optionally incorporated into memory sticks or other disc applications, as may be desired, wherein the physical fretboard can be rendered virtual through the use of game consoles and multi-media workstations, and the diatonic notes of the virtual fretboard can be incorporated into games, teaching systems, training and performing.

4. A method for forming a sequential depiction on a printed item made of paper, plastic, metal or other suitable material and having a shape relatively corresponding to that of the fretboard of a guitar for mapping and organizing the seemingly random distribution of diatonic tones on a regular 6-string guitar fretboard into memorable symmetrical arrays for guitar instruction and playing, the method comprising the steps of:
i. Depicting the guitar fretboard positioned horizontally with only the tones of the diatonic musical key of C visible at its corresponding positions on a portion of paper, plastic, metal or other suitable material having the shape of the fretboard on a standard 6-string guitar
ii. Identifying Axis positions in the key of C on the depiction of the fretboard, the first three Axis positions positioned at the nut, the 5^{th} fret and 10^{th} fret, with the same Axis positions repeated at the 12^{th} fret and 17^{th} fret, and so on, over the entire length of the depiction of the fretboard, the nut being the Phrygian axis, the 5^{th} fret being the Aeolian axis and the 10^{th} fret being the Dorian axis, the Phrygian axis comprising the tones E, A, D, G, B and E, the Aeolian axis comprising A, D, G, C, E an A, and the Dorian axis comprising D, G, C, F, A and D;
iii. Delineating and separating the depiction of the fretboard into an Upper String Group and a Lower String Group, the Upper String Group comprising the 1^{st}, 2^{nd}, 3^{rd} and 4^{th} strings of the 6-string guitar fretboard, the Lower String Group comprising the 4^{th}, 5^{th} and 6^{th} strings of the 6-string guitar fretboard;
iv. Delineating and highlighting positions of the diatonic tones of E, F, B and C in the Upper String Group on the depiction of the fretboard, forming diatonic Halfsteps;
v. Linking and delineating diatonic tones outside of the diatonic Halfsteps in a curvilinear manner and extending from the diatonic Halfsteps at the 5^{th} fret center Axis in the Upper String Group on the depiction of the fretboard, forming two spiral arms on the depiction of the fretboard recognizing the symmetrical pattern created therewith;
vi. Delineating and highlighting positions of the diatonic tones of E, F, B and C in the Lower String Group on the depiction of the fretboard, forming diatonic Halfsteps;
vii. Adding diatonic tones other than E, F, B and C in the Lower String Group on the depiction of the fretboard;
viii. Replacing the alphabetical note names of C, D, E, F, G , A and B on the depiction of the fretboard with Roman numerals I, II, III, IV, V, VI and VII, to indicate the diatonic scale degrees;
ix. Delineating a symmetrical pattern formed within the area from the nut to the 10^{th} fret on the depiction of the fretboard being bound by two Axes and having a central Axis, the central Axis being named the Aeolian Axis, thus depicting the symmetrical pattern as Primary Symmetry;
x. Delineating a symmetrical pattern formed within the area spanning twelve frets on the depiction of the fretboard bound by two Aeolian Axes and having a Void in the middle, the Void being the fret position comprising tones ndot belonging to the musical key being depicted, the Void bound by the Dorian and Phrygian Axes, thus depicting the symmetrical pattern as Secondary Symmetry;
xi. and;
xii. Attaching at least 1 printed depiction of i-x to the fretboard of a guitar to facilitate instruction and playing of the guitar.

5. A method for guitar playing and instruction which enhances memorization of the relative position of random distributed diatonic musical keys on a regular 6-string guitar fretboard by mapping, organizing, delineating and highlighting the diatonic musical keys into memorable symmetrical arrays, the method comprising:
i. Visualizing the guitar fretboard positioned horizontally with only the diatonic tones of C visible at their corresponding positions;
ii. Identifying Axis positions in the key of C on the depiction of the fretboard, the first three Axis positions positioned at the nut, the 5^{th} fret and 10^{th} fret, with the same Axis positions located at the 12^{th} fret and 17^{th} fret, and so on, over the entire length of the depiction of the fretboard, the nut being the Phrygian axis, the 5^{th} fret being the Aeolian axis and the 10^{th} fret being the Dorian axis, the Phrygian axis comprising the tones E, A, D, G, B and E, the Aeolian axis comprising A, D, G, C, E an A, and the Dorian axis comprising D, G, C, F, A and D;
iii. Delineating and separating the depiction of the fretboard into an Upper String Group and a Lower String Group, the Upper String Group comprising the 1^{st}, 2^{nd}, 3^{rd} and 4^{th} strings of the 6-string guitar fretboard, the Lower String Group comprising the 4^{th}, 5^{th} and 6^{th} strings of the 6-string guitar fretboard;
iv. Delineating and highlighting positions of the diatonic tones of E, F, B and C in the Upper String Group, forming diatonic Halfsteps;
v. Linking and delineating diatonic tones outside of the diatonic Halfsteps in a curvilinear manner and extending from the diatonic Halfsteps at the center Axis in the Upper String Group, forming two spiral arms, recognizing the symmetrical pattern created therewith;
vi. Delineating and highlighting positions of the diatonic tones of E, F, B and C in the Lower String Group, forming diatonic Halfsteps;
vii. Adding diatonic tones other than E, F, B and C in the Lower String Group;
viii. Replacing the alphabetical note names of C, D, E, F, G , A and B with Roman numerals I, II, III, IV, V, VI and VII, to indicate the diatonic scale degrees;
ix. Delineating a symmetrical pattern formed within the area spanning eleven frets on the fretboard having bound by two Axes and having a central Axis, thus recognizing the symmetrical pattern as Primary Symmetry;
x. Delineating a symmetrical pattern formed within the area spanning fifteen frets on the fretboard bound by Aeolian Axes and having a Void in the middle, thus recognizing the symmetrical pattern as Secondary Symmetry;
xi. Delineating respective symmetrical patterns in the Upper String Group and Lower String Group; and
xii. Highlighting symmetrical arrays by visual aids wherein the visual aids are painted onto or inlaid into the fretboard

6. (canceled)

7. (canceled)

8. A method of diatonic mapping of the guitar fretboard by placing printed visual markers directly onto the fretboard of a guitar consisting of the following steps:
Placing printed markings showing the note positions of the key of C directly on the fretboard of a guitar;
Showing with printed markings placed directly on the fretboard only those notes which align at the nut, 5^{th} fret, 10^{th} fret, 12^{th} fret, and 17^{th} fret in the key of C;
Delineating with printed markings the four upper strings (1 thru 4) and the three lower strings (4 thru 6) directly on the fretboard;
Delineating with printed markings the positions of the notes E, F, B, C in the upper four strings and highlighting their symmetrical locations directly on the fretboard;
Delineating with printed markings the positions of the notes E, F, B, C in the lower three strings and highlighting their symmetrical locations directly on the fretboard;
Delineating with printed markings the positions of the notes E, F, B, C in the lower three strings directly on the fretboard;
Delineating the remaining natural tones added in the Upper String Group directly on the fretboard as two spiral arms radiating symmetrically from the central Axis;
Adding printed markings showing the remaining natural tones in the Lower Sting Group directly onto the fretboard;
Replacing the alphabetical note names with with printed markings showing Roman numerals indicating the diatonic scale degrees directly on the fretboard;
Depicting the note array with printed markings showing as an eleven fret span with a central Axis and Axes at each end directly on the fretboard;
Depicting the note array with printed markings as a fifteen fret span directly on the fretboard with instances of the center Axis of the previous view placed at both ends and the former Outer Axes at the middle;
Depicting the Primary and Secondary Symmetries with the Upper and Lower Sting Groups separated with printed markings directly on the fretboard; and
Showing diatonic scales and modes as printed geometric patterns superimposed directly on the fretboard in symmetrical relationships.

9. A guitar fretboard having markers for mapping and organizing the seemingly random distribution of diatonic tones on the fretboard into memorable symmetrical arrays suitable for guitar instruction and playing, the guitar fretboard consisting of the following:
xiii. Visual markers located on the guitar fretboard indicating the diatonic musical keys of C at their corresponding positions;
xiv. Visual markers located on the guitar fretboard identifying Axis positions in the key of C on the fretboard, the first three Axis positions positioned at the nut, the 5^{th} fret and 10^{th} fret, with subsequent Axis positions located at the 12^{th} fret and 17^{th} fret, and so on, over the entire length of the fretboard;
xv. Visual markers located on the guitar fretboard delineating and separating the fretboard into an Upper String Group and a Lower String Group, the Upper String Group being the area encapsulated between the first string and the fourth sting of the 6-string guitar fretboard, the Lower Sting Group being the area encapsulated between the fourth string and the sixth string of the 6-string guitar fretboard;
xvi. Visual markers located on the guitar fretboard delineating and highlighting positions of the diatonic musical keys of E, F, B and C in the Upper String Group, forming diatonic Halfsteps;
xvii. Visual markers located on the guitar fretboard linking and delineating diatonic tones outside of the diatonic Halfsteps in a curvilinear manner and extending from the diatonic Halfsteps at the center Axis in the Upper String Group, forming two spiral arms recognizing the symmetrical pattern created therewith;
xviii. Visual markers located on the guitar fretboard delineating and highlighting positions of the diatonic tones of E, F, B and C in the Lower String Group, forming diatonic Halfsteps;
xix. Visual markers located on the guitar fretboard showing diatonic tones other than E, F, B and C in the Lower String Group;
xx. Visual markers located on the guitar fretboard replacing the alphabetical note names of C, D, E, F, G , A and B with Roman numerals I, II, III, IV, V, VI and VII, to indicate the diatonic scale degrees;
xxi. Visual markers located on the guitar fretboard delineating a symmetrical pattern formed within the area spanning eleven frets on the fretboard having bound by two Axes and having a central Axis, thus recognizing the symmetrical pattern as Primary Symmetry;
xxii. Visual markers located on the guitar fretboard delineating a symmetrical pattern formed within the area spanning fifteen frets on the fretboard bound by two Aeolian Axes and having a Void in the middle, thus recognizing the symmetrical pattern as Secondary Symmetry; and
xxiii. Visual markers located on the guitar fretboard delineating respective symmetrical patterns in the Upper String Group and Lower String Group.

10. The guitar fretboard of claim 9, wherein the visual markers are printed.

11. The guitar fretboard of claim 9, wherein the visual markers are electronic.

12. The guitar fretboard of claim 9, wherein the visual markers are controlled electronically.

13. The guitar fretboard of claim 9, wherein the visual markers are illuminated.

14. A method of diatonic mapping of the guitar fretboard by placing visual markers directly onto the fretboard of a guitar consisting of the following steps:
Placing visual markers showing the note positions of the key of C directly on the fretboard of a guitar;
Showing with visual markers placed directly on the fretboard only those notes which align at the nut, 5^{th} fret, 10^{th} fret, 12^{th} fret, and 17^{th} fret in the key of C; Delineating with visual markers the four upper strings (1 thru 4) and the three lower strings (4 thru 6) directly on the fretboard;
Delineating with visual markers the positions of the notes E, F, B, C in the upper four strings and highlighting their symmetrical locations directly on the fretboard;
Delineating with visual markers the positions of the notes E, F, B, C in the lower three strings and highlighting their symmetrical locations directly on the fretboard;
Delineating with visual markers the positions of the notes E, F, B, C in the lower three strings directly on the fretboard;
Delineating the remaining natural tones added in the Upper String Group directly on the fretboard as two spiral arms radiating symmetrically from the central Axis;
Adding visual markers showing the remaining natural tones in the Lower String Group directly onto the fretboard;
Replacing the alphabetical note names with visual markers showing Roman numerals indicating the diatonic scale degrees directly on the fretboard;
Depicting the note array with visual markers showing as an eleven fret span with a central Axis and Axes at each end directly on the fretboard;
Depicting the note array with visual markers as a fifteen fret span directly on the fretboard with instances of the center Axis of the previous view placed at both ends and the former Outer Axes at the middle;
Depicting the Primary and Secondary Symmetries with the Upper and Lower String Groups separated with visual markers directly on the fretboard; and
Showing diatonic scales and modes as visual geometric patterns superimposed directly on the fretboard in symmetrical relationships.

15. The method of claim 14, wherein the visual markers are controlled electronically.

16. The method of claim 14, wherein the visual markers are illuminated electronically.
